(19) United States
(12) Patent Application Publication
(10) Pub. No.: US 2015/0356630 A1
(43) Pub. Date: Dec. 10, 2015

(54) METHOD AND SYSTEM FOR MANAGING SPAM

(71) Applicant: ATIF HUSSAIN, HYDERABAD (IN)

(72) Inventor: ATIF HUSSAIN, HYDERABAD (IN)

(21) Appl. No.: 14/299,649

(22) Filed: Jun. 9, 2014

(51) Int. Cl. G06Q 30/02; G06Q 10/10; H04L 12/58

(52) U.S. Cl. CPC G06Q 30/0273; H04L 51/12; G06Q 10/107

(57) ABSTRACT

Embodiments of the present invention disclose a method for managing communication from a sender to a receiver. The method comprises receiving a deposit from the sender in favor of the receiver for communicating with the receiver, refunding of the deposit by the receiver in favor of the sender in response to the receiver responding to the communication, and forfeiting of the deposit by the receiver in response to the receiver rejecting the communication, thereby facilitating controlling of nuisance communication. In addition, embodiments of the present invention disclose a method for managing communications from a sender to a recipient. The method comprises receiving a deposit from the sender in favor of the recipient for communicating with the recipient, refunding of the deposit by the recipient in favor of the sender as an acknowledgement in response to the received communication and forfeiting of the deposit by the recipient in response to detection of at least one of spam and unsolicited communications and rejection of the same by the recipient, thereby facilitating controlling of nuisance calls. Still other embodiments of the present invention disclose a system for managing communication from a sender to a receiver. The system comprises a first communication subsystem used by the sender for at least one of sending and receiving communications, a second communication subsystem used by the receiver for at least one of sending and receiving communications, and a service provider network subsystem for facilitating communication between the sender and receiver. The service provider network comprises a host computing subsystem. The host computing subsystem comprises a billing module, wherein the billing module is capable of receiving a deposit from the sender in favor of the receiver for communicating with the receiver; and wherein the billing module is capable of refunding the deposit by the receiver to the sender in response to the receiver responding to the communication; and wherein the billing module is capable of forfeiting the deposit by the receiver in response to the receiver rejecting the communication, thereby facilitating controlling of nuisance communication. The service provider charges the receiver a fee for the services rendered to the receiver commensurate to a threshold declared and set by receiver in connection with the deposit.

### BACKGROUND OF THE INVENTION

1. Field of the Invention

Embodiments of the present invention generally relate to managing spam, and more particularly, to a method and system for controlling and monitoring unsolicited communications, such as calls, messages and e-mails, from sender (or caller) to receiver (or callee), with enhanced qualitative and quantitative parameters, such as easy usability, highly economical, easy design and implementation, low complexity, high return (or Return On Investment or ROI) with low risk on the risk-return spectrum (or tradeoff).

2. Description of the Related Art

In the past, snail mail was the only means of communication. Snail mails took long time to reach a given destination from a given source, and required hard cash. The snail mail service was used carefully and sensibly. As a consequence, only essential communications were made using the snail mail service.

Later on, the advent of telecommunication technologies made access to electronic communications, such as telephone calls, Short Message Services (SMSes), e-mails, online chat, and all that, either at low-cost or free to almost everyone including spammers, telemarketers, sales promoters, and stalkers.

While the most widely recognized form of spam is e-mail spam, the term is applied to similar abuses in other media. For instance, Instant Messaging (IM), newsgroup and forum, mobile phone, social networks, online game, spamdexing, blog, online classified advertisements, junk fax transmissions, spam targeting video sharing sites, SPam over Internet Telephony (SPIT), academic search engine, television advertising and file sharing spam.

To prevent e-mail spam, both end users and administrators of e-mail systems use various anti-spam techniques.

Anti-spam techniques can be broken into four broad categories, namely those that require actions by individuals, such as discretion, address munging, avoid responding to spam, contact forms, disable HTML in e-mail, disposable e-mail addresses, ham (or not spam) passwords, reporting spam, and responding to spam; those that can be automated by e-mail administrators, such as authentication and reputation, challenge/response systems, checksum-based filtering, country-based filtering, DNS-based blacklists, enforcing RFC standards, greeting delay, greylisting, HELO/EHLO checking, invalid pipelining, nolisting, quit detection, honeypots, hybrid filtering, outbound spam protection, pattern detection, Pointer Record (PTR)/reverse DNS checks, rule-based filtering, sender-supported whitelists and tags, SMTP callback verification, SMTP proxy, spamtrapping, statistical content filtering and tarpits; those that can be automated by e-mail senders, such as background checks on new users and customers, confirmed opt-in for mailing lists, egress spam filtering, limit email backscatter, port 25 blocking, port 25 interception, rate limiting, spam report feedback loops, FROM field control and strong Acceptable Use Policy (AUP) and Terms of Service (TOS) agreements; and those employed by researchers and law enforcement officials, such as legislation and enforcement and analysis of spamvertisements.

Some of the anti-spam techniques may have been embedded in products, services and software to ease the burden on users and administrators. However, no single technique is a complete solution to the spam problem, and each has trade-offs between incorrectly rejecting legitimate email vs. not rejecting all spam, and the associated costs in time and effort.

Likewise, fighting mobile phone spam (or mobile spamming, text spam, m-spam, mspam, SMS spam) is complicated owing to several factors, including the lower rate of SMS spam, compared to more abused services, such as use of Internet e-mail for e-mail spam, which has allowed many users and service providers to ignore the issue, and the limited availability of mobile phone spam-filtering software. Filtering SMS spam at the recipient device is an imperfect solution in markets where users are charged to receive messages, as the user may still be charged for the message once the provider sent the message, even if software on the device blocked it from appearing on the device's display. The problem of filtering SMS spam is not present in most of the world outside the U.S., however, where users are not charged to receive messages. In addition, providers may fear liability should a legitimate message of an emergency nature be blocked. Nonetheless, many providers voluntarily provide the subscribers technical means for mitigating unsolicited SMS messages.

Although, telephone spam is comparable to e-mail spam, however owing to the synchronous nature of the telephone communication, different mitigation methods are required. To the extent that mitigation of telephone spam over Session Initiation Protocol (SIP) is concerned, Request for Comments (RFC) 5039 (SIP and Spam) broadly contains some basic methods, such as white and black lists, consent-based communications, reputation systems, address obfuscation and limited-use addresses, turing tests, captchas, computational puzzles, payment and legal actions.

One proposed method focuses on strong identification of the caller, for example as described in RFC 4474 (Enhancements for Authenticated Identity Management in SIP) helps mitigation of SPIT. In a Public switched telephone network (PSTN), the caller ID permits caller identification, however at least the displayed caller ID can be spoofed, i.e. caller ID spoofing.

Another proposed method focuses on the reputation and the behavior of callers. For example, a Voice Spam Detector (VSD) a multi-stage spam filter based on trust and reputation. Both, e-mail and Instant Messaging (IM) are subject, of course, to spam however are controlled to some extent through filters, which block or intercept certain messages. The filters provide a measure of protection as the filters are able to analyze text based on the content before accepting or rejecting the correspondence. However, in the case of voice messages it is impossible to predetermine the content of a future voice session.

Another proposed method facilitates development of blacklists and white lists. For example, a statistical analysis of the signaling traffic and in particular the call frequency can be used to detect anomalies, to observe and finally to black-list suspicious callers. However, blacklists and white lists have a limited success in curbing e-mail spam and may only be applied to call spam. Further, it is hard to keep the lists updated. Still further, some people, like business men, may want to accept calls from just about anyone.

Another proposed method for SPIT detection and mitigation can also be based on the caller's audio data. The caller's audio data based SPIT detection and mitigation method uses audio identification techniques, similar to music identification, to detect calls with identical audio data including certain degradations, for example noise and different audio codecs. A robust acoustic fingerprint is derived from spectral parameters of the audio data and replayed calls are identified by a comparison of fingerprints. However, only a prototype solution has been developed within the VIAT project for method for the identification and blocking of telephone spam.

Another proposed method for combating spam is through legal actions, for example by declaring spam illegal. However, it is byzantine to define an unsolicited call, message or e-mail. In addition, there is also some doubt whether a spam related legislation will be effective in VoIP environment since it is hard to enforce legislation across national boundaries.

Another proposed method for identification of spam suggests call pattern analyses to recognize possible VoIP spammers, for instance gray-leveling. For example, a caller who attempts to make more calls than a pre-defined threshold of calls over a time period is considered to be a spammer. However, current network hardware would be unable to accurately identify spam from millions of legitimate voice calls in real-time.

Another proposed method suggests implementation of a challenge-response test via application of a turing test on a caller to identify a robot-caller, usually spammer. The failure of test causes the call to be ended. Turing test is effective but to change millions of legitimate voice call flows to add a challenge-response test is a problem.

Hitherto, there is little information available on implementations of SPIT mitigation measures by telephone companies. Mistakenly, SPIT is generally not yet considered to be problem with similar relevance as e-mail spam.

Today a number of mobile communication users are taking advantage of different services provided by mobile communication operators. One specific but frequently encountered problem is a callee gets a call from an unknown number, for instance the call may be at least one from a known person but with an unknown number, an unknown person but with unknown number and an unknown person with an unknown number. Likewise, another specific but frequently encountered problem is a callee may receive a call, which the callee prefers not to receive owing to lack of information about the caller, for instance during meetings a callee picks up a call from the unknown number and finds that the call is regarding some promotional advertisement. The callee fails to find any reference to the unknown number.

Based on some known mundane solutions for the problem of calls from unknown numbers, the callee has one or more options, such as 1) pick up the call and then callee could know the caller, 2) ask the mobile communication operator to find the caller's identity. However, there is lack of some identification system for a callee to identify the unknown number and decide whether to pick up or cut the call.

Traditional voice networks employ services, such as privacy detectors, to deal with potentially annoying calls. For example, a BellSouth® Privacy Detector can decrease the number of disruptive calls thereby giving consumers an increased sense of control, privacy and security in the consumers' own home. The privacy detector intercepts calls for which the caller's number is at least one of blocked, private, unknown and unavailable, and requires the callers to identify themselves before the callers call can ring through on the callee's telephone. Another known system employs a “Do Not Call (or DNC)” list that is used to identify recipients that do not wish to receive unsolicited calls from commercial organizations.

In connection with interactive communication sessions including VoIP, an entity attempting to make an unsolicited call known herein as a spammer, adopts spam techniques developed to automatically generate unsolicited VoIP phone calls, video session, chat sessions for commercial or even elicit purposes. The difficulty in detecting and controlling the impact of VoIP spam is compounded by the fact that VoIP spam initiators may be different from the source of the spam content, such as pre-recorded messages, call center or call sales offices being delivered to the target. The spam source may also use a VoIP spam initiator or a network of spam initiators to initiate those calls on behalf of the spam source. The VoIP initiators could include compromised systems running Trojan software that are under the control of a spammer. All of these factors make it difficult to distinguish between legitimate VoIP and VoIP spam.

There are essential distinctions that make the methods of detection and prevention of e-mail and IM spam not applicable to VoIP spam. As stated previously it is practically impossible to analyze the content of a future voice session. Further, the automated “accept-reject” decision must be made in real time in most of cases. “Accept” decision here means immediate delivery of the call directly to the recipient's terminal device including message servers, email servers or Instant messenger service.

Identification of the originator may be misleading in VoIP networks as the actual spam sender's identity may be anonymized and as a result, the recipient might see the identity of a legitimate signaling gateway as a call originator which it really could be in other legitimate scenarios.

Telephone number cannot be changed as often as temporarily assigned web-based e-mail addresses, so the assumption that a telephone number is public or known to the spammer must be made, i.e. in general for detection it is not possible to rely on setup failure reports resulting from the fact that recipients do not exist.

Therefore, there is still need for methods and systems for managing spam with enhanced qualitative and quantitative parameters, such as easy usability, highly economical, easy design and implementation, low complexity, and high return (or Return On Investment or ROI) with low risk on the risk-return spectrum (or tradeoff). Specifically, there is a need for the design and implementation of a method and system for controlling and monitoring unsolicited communications, such as calls, messages and e-mails, from sender or caller to receiver or callee.

### SUMMARY OF THE INVENTION

Embodiments of the present invention disclose a method for managing calls from a caller to a callee. The method comprises receiving a deposit from the caller in favor of the callee for calling the callee, refunding of the deposit by the callee to the caller in response to the callee answering the call, and forfeiting of the deposit by the callee in response to the callee rejecting the call, thereby facilitating controlling of nuisance calls.

Embodiments of the present invention disclose a method for managing calls from a caller to a callee. The method comprises receiving a deposit from the caller in favor of the callee for calling the callee, refunding of the deposit by the callee to the caller as a response by the callee to acknowledge the call, and forfeiting of the deposit by the callee in response to spam, unsolicited or other unwanted calls to mark rejection, thereby facilitating controlling of nuisance calls.

Still other embodiments of the present invention disclose a system for managing calls from a caller to a callee. The system comprises a first communication subsystem used by the caller for at least one of calling and answering calls, a second communication subsystem used by the callee for at least one of calling and answering calls, and a service provider network subsystem for facilitating communication between the caller and callee. The service provider network comprises a host computing subsystem. The host computing subsystem, in turn, comprises a billing module, wherein the billing module is capable of receiving a deposit from the caller in favor of the callee for calling the callee, and wherein the billing module is capable of refunding the deposit by the callee to the caller in response to the callee answering the call, and wherein the billing module is capable of forfeiting the deposit by the callee in response to the callee rejecting the call, thereby facilitating controlling of nuisance calls.

Yet other embodiments of the present invention disclose a method for managing communication from a sender to a receiver. The method comprises receiving a deposit from the sender in favor of the receiver for communicating with the receiver, refunding of the deposit by the receiver in favor of the sender in response to the receiver responding to the communication, and forfeiting of the deposit by the receiver in response to the receiver rejecting the communication, thereby facilitating controlling of nuisance communication.

Still other embodiments of the present invention disclose a system for managing communication from a sender to a receiver. The system comprises a first communication subsystem used by the sender for at least one of sending and receiving communications, a second communication subsystem used by the receiver for at least one of sending and receiving communications, and a service provider network subsystem for facilitating communication between the sender and receiver. The service provider network comprises a host computing subsystem. The host computing subsystem comprises a billing module, wherein the billing module is capable of receiving a deposit from the sender in favor of the receiver for communicating with the receiver; and wherein the billing module is capable of refunding the deposit by the receiver to the sender in response to the receiver responding to the communication; and wherein the billing module is capable of forfeiting the deposit by the receiver in response to the receiver rejecting the communication, thereby facilitating controlling of nuisance communication.

Still other embodiments disclose a method or system for prospective callee (or receivers or recipients) to set a threshold to receive communication from unsolicited callers (or senders), wherein the caller calling the callee needs to deposit an amount not less than a threshold set by callee, and wherein the callee on receiving the call acknowledges the call and refunds the deposit, or rejects the call and forfeits deposit.

Still other embodiments include a method or system for service provider networks to charge the callee (or receivers or recipients) a fee for the services commensurate to the threshold declared and set by callee.

Still other embodiments disclose a computer implemented method for managing communications from a sender to a recipient comprising one or more steps. Firstly, receiving, via a recipient-owned portable computing and communications device, a deposit from the sender, via a sender-owned portable computing and communications device and a service-provider hosted server, in favor of the recipient for communicating with the recipient, secondly refunding the deposit by the recipient, via the recipient-owned portable computing and communications device and service-provider hosted server, in favor of the sender as an acknowledgement in response to the received communication, and thirdly forfeiting the deposit by the recipient in response to detection of at least one of spam and unsolicited communications and rejection of the same by the recipient, thereby facilitating controlling of nuisance calls.

These and other systems, processes, methods, objects, features, and advantages of the present invention will be apparent to those skilled in the art from the following detailed description of the preferred embodiment and the drawings. All documents mentioned herein are hereby incorporated in their entirety by reference.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts a block diagram of a system 100 for managing spam, according to one or more embodiments;

FIG. 2 depicts a flow diagram for a method for managing calls from a caller to a callee, according to one or more embodiments;

FIG. 3 depicts a flow diagram for managing communications from a sender to a recipient, according to one or more embodiments; and

FIG. 4 depicts a computer system that is a computing device and can be utilized in various embodiments of the present invention, according to one or more embodiments.

While the method and apparatus is described herein by way of example for several embodiments and illustrative drawings, those skilled in the art will recognize that the method and apparatus for managing spam, is not limited to the embodiments or drawings described. It should be understood, that the drawings and detailed description thereto are not intended to limit embodiments to the particular form disclosed. Rather, the intention is to cover all modifications, equivalents and alternatives falling within the spirit and scope of the method and apparatus for managing spam defined by the appended claims. Any headings used herein are for organizational purposes only and are not meant to limit the scope of the description or the claims. As used herein, the word “may” is used in a permissive sense (i.e., meaning having the potential to), rather than the mandatory sense (i.e., meaning must). Similarly, the words “include”, “including”, and “includes” mean including, but not limited to.

### DETAILED DESCRIPTION

Embodiments of the present invention disclose a method for managing calls from a caller to a callee. The method comprises receiving a deposit from the caller in favor of the callee for calling the callee, refunding of the deposit by the callee to the caller in response to the callee answering the call, and forfeiting of the deposit by the callee in response to the callee rejecting the call, thereby facilitating controlling of nuisance calls.

Embodiments of the present invention disclose a method for managing calls from a caller to a callee. The method comprises receiving a deposit from the caller in favor of the callee for calling the callee, refunding of the deposit by the callee to the caller as a response by the callee to acknowledge the call, and forfeiting of the deposit by the callee in response to spam, unsolicited or other unwanted calls to mark rejection, thereby facilitating controlling of nuisance calls.

Still other embodiments of the present invention disclose a system for managing calls from a caller to a callee. The system comprises a first communication subsystem used by the caller for at least one of calling and answering calls, a second communication subsystem used by the callee for at least one of calling and answering calls, and a service provider network subsystem for facilitating communication between the caller and callee. The service provider network comprises a host computing subsystem. The host computing subsystem, in turn, comprises a billing module, wherein the billing module is capable of receiving a deposit from the caller in favor of the callee for calling the callee, and wherein the billing module is capable of refunding the deposit by the callee to the caller in response to the callee answering the call, and wherein the billing module is capable of forfeiting the deposit by the callee in response to the callee rejecting the call, thereby facilitating controlling of nuisance calls.

Yet other embodiments of the present invention disclose a method for managing communication from a sender to a receiver. The method comprises receiving a deposit from the sender in favor of the receiver for communicating with the receiver, refunding of the deposit by the receiver in favor of the sender in response to the receiver responding to the communication, and forfeiting of the deposit by the receiver in response to the receiver rejecting the communication, thereby facilitating controlling of nuisance communications.

Still other embodiments of the present invention disclose a system for managing communication from a sender to a receiver. The system comprises a first communication subsystem used by the sender for at least one of sending and receiving communications, a second communication subsystem used by the receiver for at least one of sending and receiving communications, and a service provider network subsystem for facilitating communication between the sender and receiver. The service provider network comprises a host computing subsystem. The host computing subsystem comprises a billing module, wherein the billing module is capable of receiving a deposit from the sender in favor of the receiver for communicating with the receiver; and wherein the billing module is capable of refunding the deposit by the receiver to the sender in response to the receiver responding to the communication; and wherein the billing module is capable of forfeiting the deposit by the receiver in response to the receiver rejecting the communication, thereby facilitating controlling of nuisance communications.

Still other embodiments disclose a method or system for prospective callee (or receivers or recipients) to set a threshold to receive communication from unsolicited callers (or senders), wherein the caller calling the callee needs to deposit an amount not less than a threshold set by callee, and wherein the callee on receiving the call acknowledges the call and refunds the deposit, or rejects the call and forfeits deposit.

Still other embodiments include a method or system for service provider networks to charge the callee (or receivers or recipients) a fee for the services commensurate to the threshold declared and set by callee.

Still other embodiments disclose a computer implemented method for managing communications from a sender to a recipient comprising one or more steps. Firstly, receiving, via a recipient-owned portable computing and communications device, a deposit from the sender, via a sender-owned portable computing and communications device and a service-provider hosted server, in favor of the recipient for communicating with the recipient, secondly refunding the deposit by the recipient, via the recipient-owned portable computing and communications device and service-provider hosted server, in favor of the sender as an acknowledgement in response to the received communication, and thirdly forfeiting the deposit by the recipient in response to detection of at least one of spam and unsolicited communications and rejection of the same by the recipient, thereby facilitating controlling of nuisance communications.

These and other systems, processes, methods, objects, features, and advantages of the present invention will be apparent to those skilled in the art from the following detailed description of the preferred embodiment and the drawings. All documents mentioned herein are hereby incorporated in their entirety by reference.

Embodiments of the present invention disclose methods and systems for monetization of means of communication and management of spam thereof are disclosed, in accordance with the principles of the present invention.

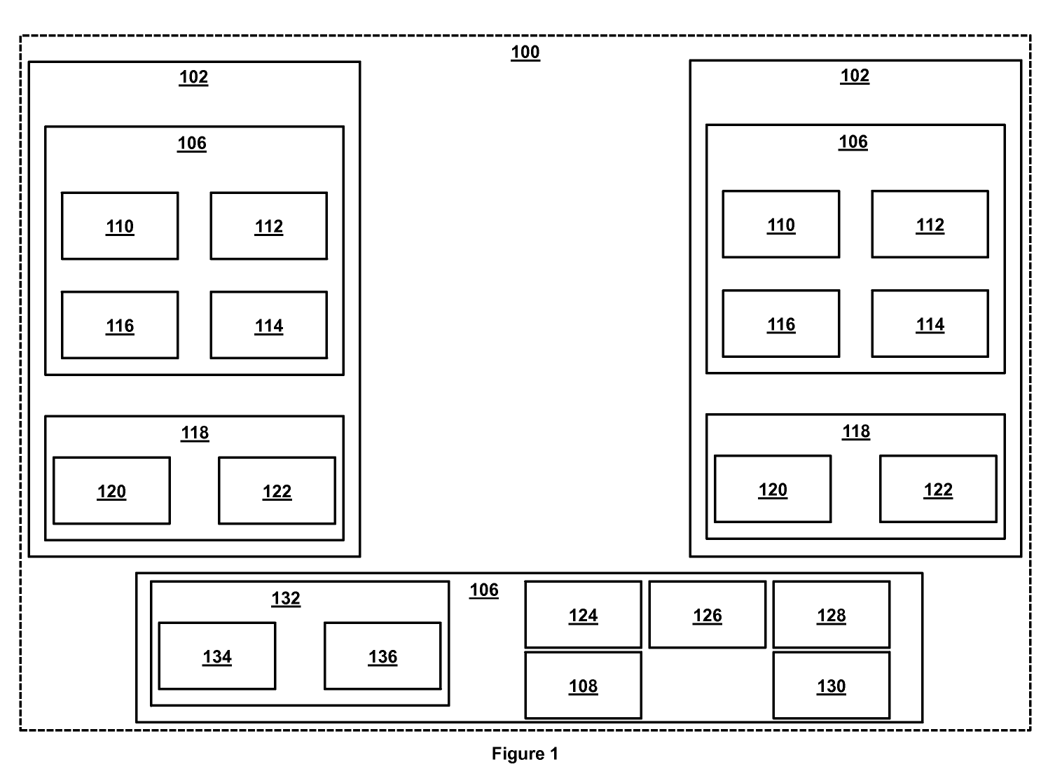

FIG. 1 depicts a block diagram of a system 100 for managing spam, according to one or more embodiments.

The system 100 may comprise a caller (or sender)-owned portable computing and communications device 102, a callee (or receiver)-owned portable computing and communications device 102 and a communications service provider network 104. Specifically, both the caller (or sender)-owned portable computing and communications device 102 and callee (or receiver)-owned portable computing and communications device 102 may be used interchangeably as a sender and receiver.

In some embodiments, as depicted in FIG. 1, the caller (or sender)-owned portable computing and communications device 102 may be coupled to the callee (or receiver)-owned portable computing and communications device 102. Specifically, the caller (or sender)-owned portable computing and communications device 102 may be bi-directionally communicably coupled to the callee (or receiver)-owned portable computing and communications device 102 via the communications service provider network 104.

Both the caller (or sender)-owned and callee (or receiver)-owned portable computing and communications devices 102 may be capable of communicating with the each other via the communications service provider network 104.

In some embodiments, as depicted in FIG. 1, both the caller (or sender)-owned and callee (or receiver)-owned portable computing and communications devices 102 may comprise a first wireless transceiver 110, a first Micro Processing Unit (MPU) 112, a first I/O unit 114, first set of support circuits 116 and a first memory unit 118.

In some embodiments, the communications service provider network possesses client-server network architecture. For example, and in no way limiting the scope of the invention, the network architecture is client-server. However, in some embodiments, the network architecture may be any other type architecture, such as peer-to-peer. The communications service provider network may comprise a service provider hosted server. The service provider hosted server may be capable of implementing a server-side of proprietary application software, whereas the clients, for instance one or more sender (or caller-owned) and receiver (or callee-owned) portable computing and communications devices may comprise of a client-side of proprietary application software, and thus may be capable of implementing the same. In some embodiments, the delivery model in connection with the proprietary application software may be a Software-as-a-Service (SAAS) based subscription model. Thus, in use, the senders (or callers) and receiver (or callees) may be required to subscribe to the proprietary application software. For example, the senders (or callers) and receiver (or callees) may buy or purchase at least one of a monthly, quarterly, biannual and annual subscription for the proprietary application software. In some embodiments, the delivery model of the proprietary software may be at least one of pre-installed software (also known as bundled software or crapware), Software Plus Services (S+S), digital distribution (also called content delivery, online distribution, or electronic software distribution (ESD), among others), file sharing and on-premises software (sometimes abbreviated as “on-prem” software).

In some embodiments, the first memory unit 118 comprises client-side proprietary application software 120 and a first Operating System (OS) 122. For example, and in no way limiting the scope of the invention, the client-side proprietary application software 120 may be at least one of a portable and mobile application software (or mobile app). Likewise, the first OS 122 may be at least one of a portable and mobile OS.

The communications service provider network 104 comprises a service provider hosted server 106. In some embodiments, the service provider hosted server 106 is in essence a host computing subsystem. The host computing subsystem 106 comprises a second wireless transceiver 124, a second Micro Processing Unit (MPU) 126, a second I/O unit 128, a second set of support circuits 130 and a second memory unit 132.

The service provider hosted server 106 may comprise a billing and payment module 108. The billing and payment module 108 implements a group of processes facilitating collection of consumption information, calculation of charging and billing information, production of bills to customers, processing the payments made by the customers and management of debt collection and performance of overall analytics.

In some embodiments, the service provider hosted server 106 may be capable of generating and storing in the second memory unit 132 a Call Detail Record (CDR). In general, the CDR comprises metadata comprising data fields that describe a specific instance of a telecommunication transaction, but does not include the content of that transaction. By way of simplistic example, the CDR describing a particular phone call may include the phone numbers of both the calling and receiving parties, the start time, and duration of the call. In actual modern practice, CDRs are much more detailed, and comprise one or more attributes, for instance the phone number of the subscriber originating the call (calling party), the phone number receiving the call (called party), the starting time of the call (date and time), the call duration (or Average Call Duration (ACD)), the Answer-Seizure Ratio (ASR), the call volume, the billing phone number that is charged for the call, the identification of the telephone exchange or equipment writing the record, a unique sequence number identifying the record, additional digits on the called number used to route or charge the call, the disposition or the results of the call, indicating, for example, whether or not the call was connected, the route by which the call entered the exchange, the route by which the call left the exchange, call type (voice, SMS, etc.) and any fault condition encountered. In some embodiments, the service provider hosted server 106 may be capable of generating and storing in the second memory unit 132 a Customer Proprietary Network Information (CPNI). The CPNI is the data collected by telecommunications companies about a consumer's telephone calls. The CPNI includes the time, date, duration and destination number of each call, the type of network a consumer subscribes to, and any other information that appears on the consumer's telephone bill. In some embodiments, the service provider hosted server 106 may be capable of generating and storing in the second memory unit 132 a communications data (sometimes referred to as traffic data or metadata). The communications data is information about communication. The communications data is a part of a message different from the content of the message. The communications data contains data on the communication's origin, destination, route, time, date, size, duration, or type of underlying service.

As depicted in FIG. 1, both the caller (or sender)-owned and callee (or receiver)-owned portable computing and communications devices 102 are coupled to the service provider hosted server 106. Specifically, both the caller (or sender)-owned and callee (or receiver)-owned portable computing and communications devices 102 are bi-directionally communicably coupled to the service provider hosted server 106 via the communications service provider network 104.

Both the caller (or sender)-owned and callee (or receiver)-owned portable computing and communications devices 102 are capable of communicating with the service provider hosted server 106 via the communications service provider network 104.

In some embodiments, the second memory unit 132 comprises server-side proprietary application software 134 and a second Operating System (OS) 136. For example, and in no way limiting the scope of the invention, the server-side proprietary application software 134 may be at least one of a portable and mobile application software (or mobile app). Likewise, the second OS 136 may be at least one of a portable and mobile OS.

In some embodiments, the means of communication may at least one of email, phone, Short Message Service (SMS), and the like.

In some scenarios, an ordinary user (or caller) may be at least one of desirous and intending to call a celebrity (or callee). A communications service provider may request the user to make a deposit for calling the celebrity. For example, and in no way limiting the scope of the invention, the deposit may be a conditionally refundable security deposit.

In operation, the ordinary user (or caller) may initiate or activate the client-side proprietary application software 120 on the caller (or sender)-owned portable computing and communication device 102. Specifically, the ordinary user (or caller) may initiate or activate the client-side proprietary application software 120 via logging in to the client-side proprietary application software 120 using his/her user credentials, for instance a combination of a unique User Identification (UID) and a corresponding Password (PWD) assigned to the user upon registration. In some embodiments, the ordinary user may use the Graphical User Interface (GUI) of the proprietary application software 120 to make a call. Upon initiating a call from within the GUI of the proprietary application software 120, the ordinary user is requested to make a conditionally refundable security deposit.

In some embodiments, the service provider manages a common pool of funds comprising conditionally refundable security deposits made by one or more users via usage of the client-side of the proprietary application software installed on one or more caller (or sender)-owned portable computing and communication devices.

In some scenarios, in the event that the celebrity (or callee) receives (or accepts) and answers the call from the ordinary user (or caller); the celebrity (or callee) authorizes the service provider to refund the conditionally refundable security deposit.

In some scenarios, in the event that the celebrity (or callee) at least one of intentionally and unintentionally rejects the call from the ordinary user (or caller), the conditionally refundable security deposit from the ordinary user (or caller) is forfeited.

In some scenarios, in the event that the celebrity (or callee) is at least one of permanently and provisionally unavailable owing to one or more valid reasons, the ordinary user (or caller) is permitted to make one or more call attempts against the conditionally refundable security deposit made by the ordinary user (or caller). For example, and in no way limiting the scope of the invention, the ordinary user (or caller) may be permitted to make at least three (3) call attempts to achieve a connected call. In some scenarios, in the event that the ordinary user (or caller) fails to connect to the celebrity (or callee) despite the permitted number of call attempts, the conditionally refundable security deposit from the ordinary user (or caller) is forfeited.

In some embodiments, the service provider performs profiling of a call based on an overall profile of at least one of the caller, callee, call details and a combination thereof. For example, the overall profile of the caller may comprise of call behaviour profile, demographic profile, personal profile, service provider and network details, call details, and the like, of the caller. Likewise, the overall profile of the callee may comprise of call behaviour profile, demographic profile, personal profile, service provider and network details, call details, and the like, of the callee. Still likewise, the overall call profile may comprise of one or more parameters, such as at least one of the frequency of calls, average duration of calls, time of day, number of failed call attempts, number of successful call attempts, call setup success rate, and a combination thereof, between at least one of a given caller and a given callee, a given caller and given callees, given callers and a given callee, given callers and given callees and a combination thereof.

In some embodiments, the system facilitates formation of a common fund comprising conditionally refundable security deposits from multiple users. Specifically, the system facilitates circulation of conditionally refundable security deposits from multiple users.

In some embodiments, monetization of e-mail and management of e-mail spam thereof is disclosed, in accordance with the principles of the present invention. In some scenarios, a sender may be at least one of desirous and intending to send an e-mail to a celebrity (or receiver). A communications service provider may request the user to make a deposit for e-mailing to the celebrity. For example, and in no way limiting the scope of the invention, the deposit may be a conditionally refundable security deposit.

In some embodiments, adaptive, dynamic trainability, and thus learnability, of the system renders the system artificially intelligent.

In some embodiments, design and implementation of a context-aware system for managing spam is disclosed, in accordance with the principles of the present invention. Specifically, the system may be capable of being trained via usage over a period of time, and thus the system may be capable of learning based on the undergone training.

The system is trainable, and thus learns, the context in connection with communications between senders (or callers) and receivers (or callees). In some scenarios, in the event that a sender (or caller) sends an information or calls using one or more method of communication via one or more medium of communication, the system is capable of capturing the details in connection with at least one of the sender (or caller), receiver (or callee), method of communication, medium of communication, message or call and related data or information, analyzing the same, profiling the sender (or caller), receiver (or callee) based on the corresponding overall profiles.

In some embodiments, the system is capable of recommending a receiver (or callee) whether or not to receive (or answer) or access (or retrieve) the message or call.

In some embodiments, the system is capable of providing recommendation to a given (or return or subscriber) sender (or caller) whether or not to send (or transmit) a message or call a given receiver (or callee).

In some embodiments, in the event that a given sender (or caller or return or registered user) sends or makes a follow-up (or follow on) message or call to a given receiver (or callee), the system is capable of proactively and promptly providing advance notification to the given receiver (or callee) to at least one of access (or read) and reject (or delete or leave unread) a received email (or SMS or fax or voice or multimedia message), or at least one of accept and reject an incoming the given sender (or caller). In the event that the receiver (or callee) accepts to receive (or answer) or read the call (or message) from the given sender (or caller), the system notifies the receiver (or callee) about the context of the call (or message) based on the overall profile of the sender (or caller), the context of the previous or last chain or messages or previous or last call.

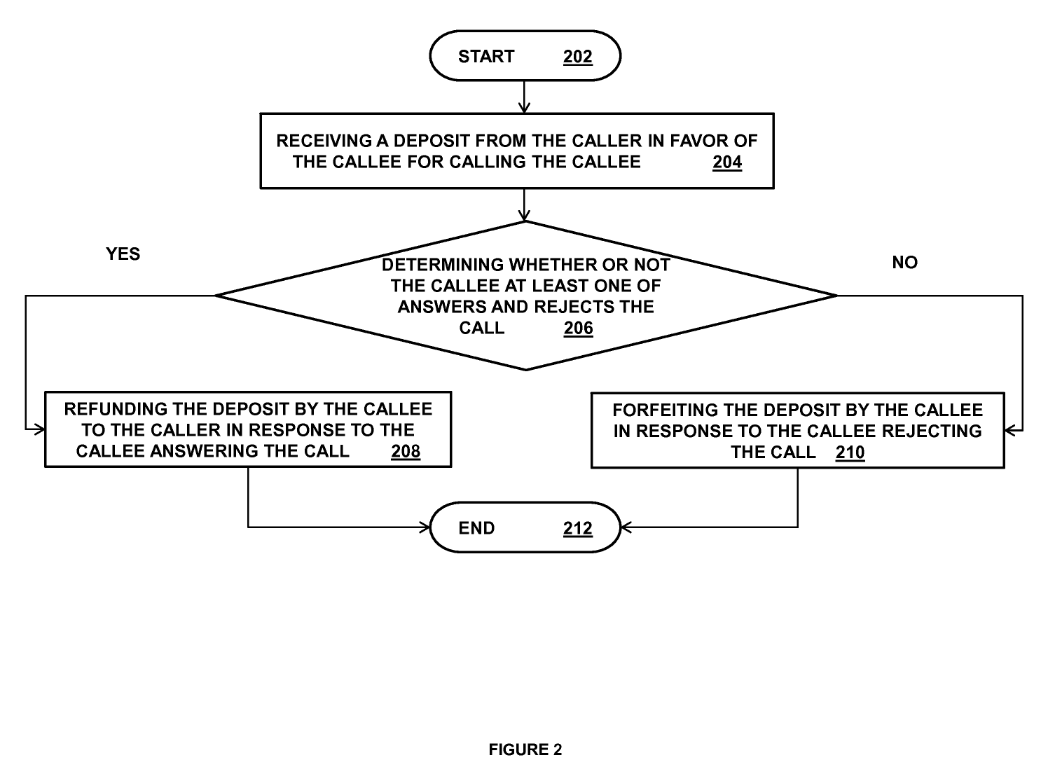

FIG. 2 depicts a flow diagram for a method for managing calls from a caller to a callee, according to one or more embodiments.

In general, mobile payment, also known as mobile money, mobile money transfer, and mobile wallet generally refer to payment services operated under financial regulation and performed from or via a mobile device. Instead of paying with at least one of cash, cheque and credit card, a consumer (or payer) may use a mobile phone to pay for a wide range of services and digital or hard goods.

In some embodiments, there are four primary models for mobile payments, namely premium SMS based transactional payments, direct mobile billing, mobile web payments (Wireless Application Protocol (WAP)) and contactless Near Field Communication (NFC).

In some scenarios involving selection and use of direct mobile billing payment option, the consumer uses the mobile billing option, such as during checkout at an e-commerce site, for instance an online gaming site, to make a payment. Upon two-(or 2-) factor authentication involving a Personal Identification Number (PIN) and One-Time-Password (OTP), the consumer's mobile account is charged for the purchase. The direct mobile billing is a true alternative payment technique that does not require the use of at least one of credit, debit cards and pre-registration at an online payment solution, such as PayPal, thus bypassing banks and credit card companies altogether.

Advantageously, in some embodiments, the selection and use of the direct mobile billing payment technique provides the following benefits: 1) security via implementation of a two-factor authentication and a risk management engine thereby preventing fraud; 2) convenience owing to no pre-registration and new mobile software requirements; 3) ease as just another option during the checkout process; 4) fast owing to completion of most transactions in less than 10 seconds; and 5) proven as seventy percent (70%) of all digital content purchased online uses the direct mobile billing payment technique.

In some scenarios involving selection and use of mobile web payments (WAP) payment option by a consumer, the consumer uses at least one of web pages displayed, additional applications downloaded and installed on the mobile phone to make a payment. The mobile web payments (WAP) technique uses WAP as underlying technology and thus inherits all the advantages and disadvantages of WAP.

For example, and in no way limiting the scope of the invention, mobile web payments (WAP) may be payments systems based on at least one of direct operator billing, credit card and online wallets.

In some scenarios involving use of the credit card based mobile web payments (WAP) systems, the user is allowed to make purchases via entry of the credit card details, in accordance with the credit card payment flow. In addition, in the event that the payment vendor is capable of automatically and securely identifying customers then card details may be recalled for future purchases, thereby turning credit card payments into simple single click-to-buy resulting in higher conversion rates for additional purchases.

In some scenarios involving use of the online wallet based mobile web payments (WAP) systems, for a first time payment a first time or new user has to register by providing his/her credentials to effectively prove his/her identity using a program running on a website hosted by a provider. Specifically, the new user is requested to provide a valid and unique phone number. Upon receiving the phone number from the new user, the provider sends the new user an SMS with a Personal Identification Number (PIN). Upon receiving the PIN from the provider, the new user enters the received PIN thereby facilitating authentication of the phone number. Further, the new user inputs the credit card info or another payment method if necessary (not necessary if the account has already been added) and validates payment. Likewise, for subsequent payments the registered user enters the PIN to the registered user and validates payments.

Advantageously, in some embodiments, the selection and use of the mobile web payments (WAP) payment technique provide the following benefits: 1) follow-on sales whereby the mobile web payment can lead back to a store or to other goods the consumer may like. The On-Device Portals (ODPs) and the mobile portal pages thereof have Uniform Resource Locator (URLs) and may be bookmarked thereby facilitating at least one of easy re-visiting and sharing; 2) high customer satisfaction from quick and predictable payments; 3) ease of use from a familiar set of online payment pages.

Advantageously, in some embodiments, the selection and use of the online wallet based mobile web payments (WAP) systems provide the following benefits: 1) the operators already have a billing relationship with the consumers, the payment will be added to their bill; 2) provides instantaneous payment; 3) protect payment details and consumer identity; 4) better conversion rates; and 5) Reduced customer support costs for merchants.

In some scenarios involving cloud-based mobile payments, the mobile payment provider participates in the middle of the transaction, which involves two separate steps. In the first step, a cloud-linked payment method is selected and payment is authorized via Near Field Communication (NFC) or an alternative method. During the first step, the mobile payment provider automatically covers the cost of the purchase with issuer linked funds. In the second step, in a separate transaction, the mobile payment provider charges the purchaser-selected cloud-linked account in a card-not-present environment to recoup the losses incurred by the mobile payment provider on the first transaction.

In some embodiments, a mobile payment service provider may implement one or more mobile payment models, in accordance with the principles of the present invention. For example, and in no way limiting the scope of the invention, the mobile payment models implemented by a mobile payment service provider may be at least one of operator-centric, bank-centric, collaboration and peer-to-peer models. Specifically, in the mobile operator acts independently to deploy mobile payment service. The mobile operator may provide an independent mobile wallet from the user mobile account (airtime). In some scenarios, the mobile network operator may handle the interfacing with the banking network to provide advanced mobile payment service in banked and under banked environments. In some scenarios involving implementation of the bank-centric model, a bank deploys mobile payment applications or devices to customers and ensures merchants have the required point-of-sale (POS) acceptance capability. Mobile network operators are used as simple carriers, wherein the mobile network operators bring experience to provide Quality of service (QOS) assurance. In some scenarios involving implementation of the collaboration model, collaboration among banks, mobile operators and a trusted third party is required. In some scenarios involving implementation of the peer-to-peer model, the mobile payment service provider acts independently from financial institutions and mobile network operators to provide mobile payment. For example, the Mobile Handset Initiated TransactionS (MHITS) SMS payment service uses a peer-to-peer model.

In some scenarios involving selection and use of the remote payment by SMS and credit card tokenization, despite flattening of the volume of premium SMS transactions, many cloud-based payment systems continue to use SMS for presentment, authorization, and authentication, while the payment is processed through existing payment networks, such as credit and debit card networks. The cloud-based payment systems implementing the remote payment by SMS and credit card tokenization combine the ubiquity of the SMS channel, with the security and reliability of existing payment infrastructure. Since, SMS lacks end-to-end encryption, the cloud-based payment systems implementing the remote payment by SMS and credit card tokenization employ a higher-level security strategies known as “tokenization” and “target removal”, whereby payment occurs without transmitting any sensitive account details, username, password, or PIN.

It must be noted here that to date, Point-of-Sales (POS) mobile payment solutions have not relied on SMS-based authentication as a payment mechanism, however remote payments, such as bill payments, seat upgrades on flights, and membership or subscription renewals are commonplace.

In comparison to premium short code programs which often exist in isolation, relationship marketing and payment systems are often integrated with Customer Relationship Management (CRM), Enterprise Resource Planning (ERP), marketing-automation platforms, and reservation systems. Many of the problems inherent with premium SMS have been addressed by solution providers. For example, remembering keywords is not required since sessions are initiated by the enterprise to establish a transaction specific context. Likewise, reply messages are linked to the proper session and authenticated either synchronously through a very short expiry period (every reply is assumed to be to the last message sent) or by tracking session according to varying reply addresses and/or reply options (Dynamic Dialogue Matrix).

The method 200 starts at step 202 and proceeds to step 204.

At step 204, the method 200 facilitates receiving a deposit from the caller in favor of the callee for calling the callee.

At step 206, the method facilitates determining whether or not the callee at least one of answers and rejects the call.

In the event that the callee answers the call, the method 200 proceeds to step 208. At step 208, the method 200 facilitates refunding the deposit by the callee to the caller in response to the callee answering the call. The method 200 proceeds to step 212 and ends.

In the event that the callee rejects the call, the method 200 proceeds to step 210. At step 210, the method 200 facilitates forfeiting the deposit by the callee in response to the callee rejecting the call. The method 200 proceeds to step 212 and ends.

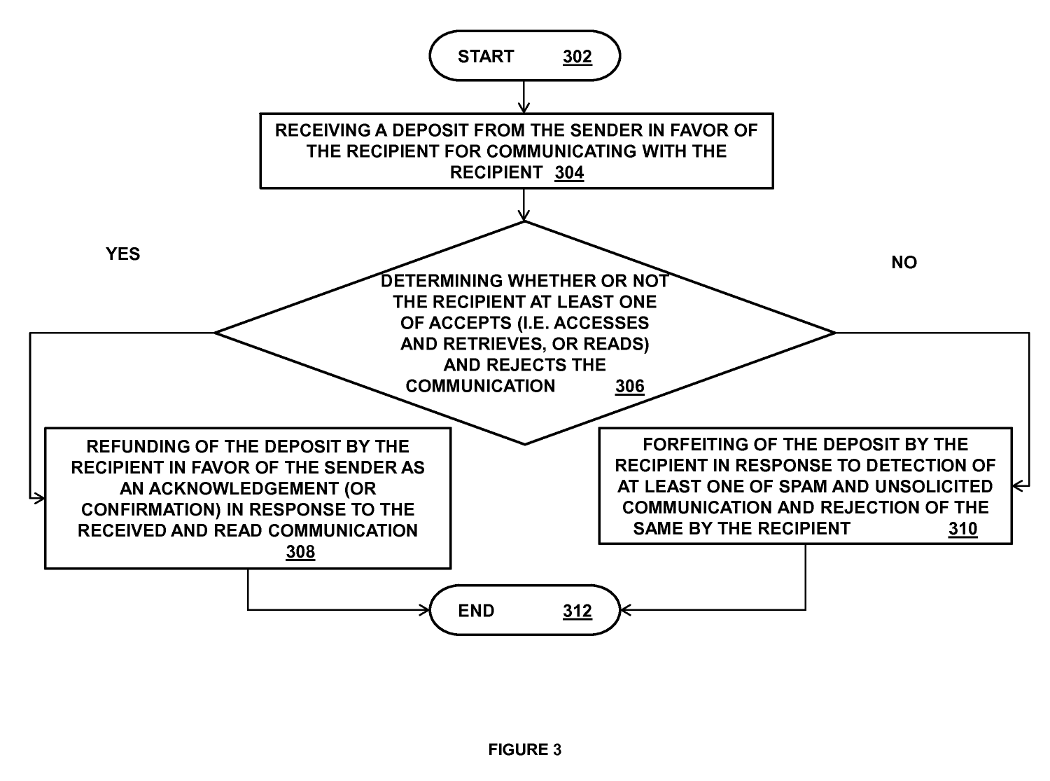

FIG. 3 depicts a flow diagram for managing communications from a sender to a recipient, according to one or more embodiments.

The method 300 starts at step 302 and proceeds to step 304.

At step 304, the method 300 facilitates receiving a deposit from the sender in favor of the recipient for communicating with the recipient.

At step 306, the method facilitates determining whether or not the recipient at least one of accepts (i.e. accesses and retrieves, or reads) and rejects the communication.

In the event that the recipient reads the communication, the method 300 proceeds to step 308. At step 308, the method 300 facilitates refunding of the deposit by the recipient in favor of the sender as an acknowledgement (or confirmation) in response to the received and read communication. The method 300 proceeds to step 312 and ends.

In the event that the recipient receives but at least one of intentionally and unintentionally fails to read the communication, the method 300 proceeds to step 310. At step 310, the method 300 facilitates forfeiting of the deposit by the recipient in response to detection of at least one of spam and unsolicited communication and rejection of the same by the recipient, thereby facilitating controlling of nuisance communications. The method 300 proceeds to step 312 and ends.

In some embodiments, one or more prospective recipients are allowed to declare and set a threshold amount in connection with the deposit to receive communications from unsolicited senders. Further, the senders are requested to deposit an amount commensurate with the threshold amount declared and set by the recipients. Still further, the recipients upon receipt of the communications at least one of acknowledge the receipt of the communication and refund the deposit upon accepting (or reading) the communication, whereas the recipients forfeit the deposit upon rejection of the communication.

### Example Computer System

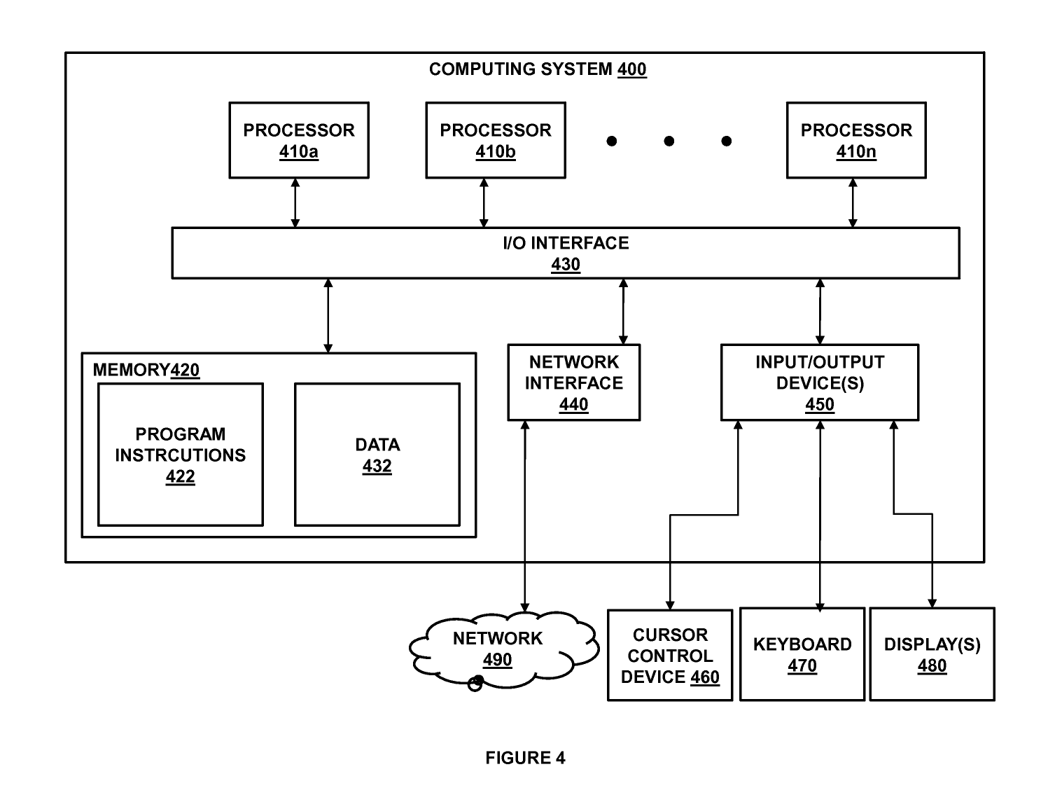

FIG. 4 depicts a computer system that is at least one of a portable computing and communications device and a computer and can be utilized in various embodiments of the present invention, according to one or more embodiments.

Various embodiments of method and apparatus for managing spam, as described herein, may be executed on one or more computer systems, which may interact with various other devices. One such computer system is computer system 400 illustrated by FIG. 4, which may in various embodiments implement any of the elements or functionality illustrated in FIGS. 1-3. In various embodiments, computer system 400 may be configured to implement one or more methods described above. The computer system 400 may be used to implement any other system, device, element, functionality or method of the above-described embodiments. In the illustrated embodiments, computer system 400 may be configured to implement one or more methods as processor-executable executable program instructions 422 (e.g., program instructions executable by processor(s) 410a-n) in various embodiments.

In the illustrated embodiment, computer system 400 includes one or more processors 410a-n coupled to a system memory 420 via an input/output (I/O) interface 430. The computer system 400 further includes a network interface 440 coupled to I/O interface 430, and one or more input/output devices 450, such as cursor control device 460, keyboard 470, and display(s) 480. In various embodiments, any of components may be utilized by the system to receive user input described above. In various embodiments, a user interface (e.g., user interface) may be generated and displayed on display 480. In some cases, it is contemplated that embodiments may be implemented using a single instance of computer system 400, while in other embodiments multiple such systems, or multiple nodes making up computer system 400, may be configured to host different portions or instances of various embodiments. For example, in one embodiment some elements may be implemented via one or more nodes of computer system 400 that are distinct from those nodes implementing other elements. In another example, multiple nodes may implement computer system 400 in a distributed manner.

In different embodiments, computer system 400 may be any of various types of devices, including, but not limited to, a personal computer system, desktop computer, laptop, notebook, or netbook computer, mainframe computer system, handheld computer, workstation, network computer, a camera, a set top box, a mobile device, a consumer device, video game console, handheld video game device, application server, storage device, a peripheral device such as a switch, modem, router, or in general any type of computing or electronic device.

In various embodiments, computer system 400 may be a uniprocessor system including one processor 410, or a multiprocessor system including several processors 410 (e.g., two, four, eight, or another suitable number). Processors 210a-n may be any suitable processor capable of executing instructions. For example, in various embodiments processors 410 may be general-purpose or embedded processors implementing any of a variety of instruction set architectures (ISAs), such as the x96, POWERPC®, SPARC®, or MIPS® ISAs, or any other suitable ISA. In multiprocessor systems, each of processors 410a-n may commonly, but not necessarily, implement the same ISA.

System memory 420 may be configured to store program instructions 422 and/or data 432 accessible by processor 410. In various embodiments, system memory 420 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing any of the elements of the embodiments described above may be stored within system memory 420. In other embodiments, program instructions and/or data may be received, sent or stored upon different types of computer-accessible media or on similar media separate from system memory 420 or computer system 400.

In one embodiment, I/O interface 430 may be configured to coordinate I/O traffic between processor 410, system memory 420, and any peripheral devices in the device, including network interface 440 or other peripheral interfaces, such as input/output devices 450. In some embodiments, I/O interface 430 may perform any necessary protocol, timing or other data transformations to convert data signals from one components (e.g., system memory 420) into a format suitable for use by another component (e.g., processor 410). In some embodiments, I/O interface 430 may include support for devices attached through various types of peripheral buses, such as a variant of the Peripheral Component Interconnect (PCI) bus standard or the Universal Serial Bus (USB) standard, for example. In some embodiments, the function of I/O interface 430 may be split into two or more separate components, such as a north bridge and a south bridge, for example. Also, in some embodiments some or all of the functionality of I/O interface 430, such as an interface to system memory 420, may be incorporated directly into processor 410.

Network interface 440 may be configured to allow data to be exchanged between computer system 400 and other devices attached to a network (e.g., network 490), such as one or more external systems or between nodes of computer system 400. In various embodiments, network 490 may include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 440 may support communication via wired or wireless general data networks, such as any suitable type of Ethernet network, for example; via telecommunications/telephony networks such as analog voice networks or digital fiber communications networks; via storage area networks such as Fiber Channel SANs, or via any other suitable type of network and/or protocol.

Input/output devices 450 may, in some embodiments, include one or more display terminals, keyboards, keypads, touchpads, scanning devices, voice or optical recognition devices, or any other devices suitable for entering or accessing data by one or more computer systems 400. Multiple input/output devices 450 may be present in computer system 400 or may be distributed on various nodes of computer system 400. In some embodiments, similar input/output devices may be separate from computer system 400 and may interact with one or more nodes of computer system 400 through a wired or wireless connection, such as over network interface 440.

In some embodiments, the illustrated computer system may implement any of the methods described above, such as the methods illustrated by the flowchart of FIG. 2. In other embodiments, different elements and data may be included.

Those skilled in the art will appreciate that computer system 400 is merely illustrative and is not intended to limit the scope of embodiments. In particular, the computer system and devices may include any combination of hardware or software that can perform the indicated functions of various embodiments, including computers, network devices, Internet appliances, PDAs, wireless phones, pagers, etc. Computer system 400 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 400 may be transmitted to computer system 400 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium or via a communication medium. In general, a computer-accessible medium may include a storage medium or memory medium such as magnetic or optical media, e.g., disk or DVD/CD-ROM, volatile or non-volatile media such as RAM (e.g., SDRAM, DDR, RDRAM, SRAM, etc.), ROM, etc.

The methods described herein may be implemented in software, hardware, or a combination thereof, in different embodiments. In addition, the order of methods may be changed, and various elements may be added, reordered, combined, omitted, modified, etc. All examples described herein are presented in a non-limiting manner. Various modifications and changes may be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

While the foregoing is directed to embodiments of the present invention, other and further embodiments of the invention may be devised without departing from the basic scope thereof, and the scope thereof is determined by the claims that follow.

1. A system for managing communication from a sender to a receiver, the system comprising:
a first communication subsystem used by the sender for at least one of sending and receiving communications;
a second communication subsystem used by the receiver for at least one of sending and receiving communications;
a service provider network subsystem for facilitating communication between the sender and receiver, the service provider network comprising:
a host computing subsystem comprising:
a billing module, wherein the billing module is capable of receiving a deposit from the sender in favor of the receiver for communicating with the receiver; and wherein the billing module is capable of refunding the deposit by the receiver to the sender in response to the receiver responding to the communication; and wherein the billing module is capable of forfeiting the deposit by the receiver in response to the receiver rejecting the communication, thereby facilitating controlling of nuisance communication.

2. The system of claim 1, wherein the service provider charges the receiver a fee for the services rendered to the receiver commensurate to a threshold amount declared and set by the receiver in connection with the deposit.

3. The system of claim 1, wherein the communication is at least one of emails, calls, SMSs, voice messages and multimedia messages.

4. A method for managing communications from a sender to a recipient comprising:
receiving a deposit from the sender in favor of the recipient for communicating with the recipient;
refunding of the deposit by the recipient in favor of the sender as an acknowledgement in response to the received communication; and
forfeiting of the deposit by the recipient in response to detection of at least one of spam and unsolicited communication and rejection of the same by the recipient, thereby facilitating controlling of nuisance communications.

5. The method of claim 4, wherein prospective recipients are allowed to declare and set a threshold amount in connection with the deposit to receive communications from unsolicited senders, and wherein the recipient is requested to deposit an amount commensurate with the threshold amount declared and set by the recipient, and wherein the recipient upon receipt of the communication at least one of acknowledges the receipt of the communication as well as refunds the deposit upon accepting the communication, and forfeits the deposit upon rejection of the communication.

6. A computer implemented method for managing communications from a sender to a recipient comprising the steps of:
receiving, via a recipient-owned portable computing and communications device, a deposit from the sender, via a sender-owned portable computing and communications device and a service-provider hosted server, in favor of the recipient for communicating with the recipient;
refunding the deposit by the recipient, via the recipient-owned portable computing and communications device and service-provider hosted server, in favor of the sender as an acknowledgement in response to the received communication; and
forfeiting the deposit by the recipient in response to detection of at least one of spam and unsolicited communication and rejection of the same by the recipient, thereby facilitating controlling of nuisance communications.
